(19) United States
(12) Patent Application Publication
(10) Pub. No.: US 2008/0011114 A1
(43) Pub. Date: Jan. 17, 2008

(54) SPINDLE DRIVE, PARTICULARLY FOR ADJUSTING A MOVING PART IN A MOTOR VEHICLE

(76) Inventors: Hans-Juergen Oberle, Rastatt (DE); Andreas Lienig, Buehl (DE)

Correspondence Address: MICHAEL J. STRIKER, 103 EAST NECK ROAD, HUNTINGTON, NY, 11743, US

(21) Appl. No.: 11/627,086

(22) Filed: Jan. 25, 2007

(30) Foreign Application Priority Data
Feb. 28, 2006 (DE) 10 2006-009 576.6

(51) Int. Cl. F16H 25/12

(52) U.S. Cl. 74/89.23

(57) ABSTRACT

In a spindle drive and a production process for such a spindle drive, in particular for adjusting a moving part in a motor vehicle, having a drive assembly, which drives a drive wheel supported on a spindle, and the drive wheel is supported rotatably in a support tube which on one end of the support tube has a receptacle for a fastener for diverting crash forces, the spindle is capable of being installed in the identical support tube in either a first installation position or a second installation position rotated by 180°.

### CROSS-REFERENCE TO A RELATED APPLICATION

The invention described and claimed hereinbelow is also described in German Patent Application DE 102006009576.6 filed on Feb. 28, 2006. This German Patent Application, whose subject matter is incorporated here by reference, provides the basis for a claim of priority of invention under 35 U.S.C. 119(a)-(d).

### BACKGROUND OF THE INVENTION

The invention relates to a spindle drive having a support tube, in particular for adjusting moving part in a motor vehicle.

In European Patent Disclosure EP 0 759 374 A2, a device for adjusting a seat in a motor vehicle has been disclosed that is capable of absorbing considerably greater forces compared to normal operation. Such forces are caused by a traffic accident, for instance. It is important here that the vehicle seat remain solidly joined to the vehicle body, to assure the function of the intended provisions (safety belt, airbag) for protecting the vehicle occupants.

In the above device, a threaded nut which receives a threaded spindle is solidly joined to the vehicle body. The threaded spindle is driven a worm gear by an electric motor that in turn is solidly joined to the seat. The gearbox of the worm gear is made from plastic and is joined to the drive motor via a further housing part. If the drive motor is actuated, the threaded spindle turns and displaces the gearbox, including the drive motor and the seat, relative to the threaded nut. In a rear-end collision, for instance, to prevent the gearbox from ripping loose from the threaded spindle, an additional U-shaped metal bracing part is provided, which connects the gearbox to the drive motor and thus to the seat via an articulated fastening bolt.

The disadvantage of this embodiment is that the U-shaped bracing part requires a relatively large amount of installation space, so there is no flexibility in installing the spindle drive.

### SUMMARY OF THE INVENTION

Accordingly, it is an object of the present invention to provide a spindle drive, particularly for adjusting a moving part in a motor vehicle, which avoids the disadvantages of the prior art.

In keeping with these objects and with others which will become apparent hereinafter, one feature of the present invention resides, briefly stated, in a spindle drive, comprising a spindle; a drive wheel supported on said spindle; a drive assembly which drives said drive wheel supported on said spindle; a support tube rotatably supporting said drive wheel and having one end provided with a receptacle for a fastener for diverting crash forces, said spindle being installable in said support tube either in a first installation position or a second installation position rotated by 180°.

The device and the method of the invention, having characteristics of the independent claims, have the advantage that because of the flexible support of the drive wheel inside the support tube, different installation positions for the spindle can be implemented. As a result, the receptacle for the fastener is located at various locations relative to the spindle, and as a result, without changing the individual components, the spindle drive can be adapted to different installation situations. For an identical position of the drive assembly with the support tube, the spindle can protrude from the support tube in the opposite direction—that is, rotated by 180°.

Advantageously, both installation positions of the spindle can be implemented without structurally changing the individual components. The fastening means to the part to be adjusted or to the vehicle body are then easy to adapt to the location of the receptacle relative to the spindle drive.

The cup-shaped bearing plate, remote from the receptacle, of the support tube can for instance be embodied integrally with the support tube or as a separate component that is inserted into the support tube or secured in the support tube. The radial inside face of the cup-shaped end serves the purpose of radially and axially supporting the drive wheel. If the cup-shaped bearing plate is embodied in one piece with the support tube, then this bearing plate can advantageously be embodied quite economically in a single work operation by means of deep drawing.

It is especially advantageous if the gearbox is reliably secured to the support tube by means of a coupling device. To that end, the gearbox, which for instance has a base body and a cap, can be mounted radially in the manner of a cuff with a form lock around the support tube.

This can be achieved for instance by providing that there are recesses in the support tube which in form-locking fashion engage the radial extensions of the gearbox. By the assembly of the gearbox, which for instance is in two parts, the support tube is simultaneously secured relative to the gearbox with the connection of the gearbox parts. The gearbox can be joined together for instance by means of screws, clips, welding, or pressing.

If the bearing plates in the support tube are embodied symmetrically to the drive wheel located on the spindle, then the installation position of the spindle can be such that without structurally changing the individual components, the spindle protrudes in one or the other direction out of the gearbox. As a result, the spindle motor, constructed as a modular system, can be adapted to various installation spaces in the motor vehicle without additional effort or expense.

In the method according to the invention for producing the spindle drive, the support tube with the built-in spindle and the drive wheel is a prefabricated module, onto which the gearbox can then be mounted. In the preassembly, depending on the application, the spindle can be located in the first or the second installation position in the support tube, without thereby affecting the further mounting of the drive assembly on the support tube.

### BRIEF DESCRIPTION OF THE DRAWINGS

FIG. 1 shows a first exemplary embodiment of a spindle drive in a first installation position of the spindle in section in accordance with the present invention; and

FIG. 2 shows a further exemplary embodiment in a second installation position of the spindle, in a section taken along the line II-II in accordance with the present invention.

### DESCRIPTION OF THE PREFERRED EMBODIMENTS

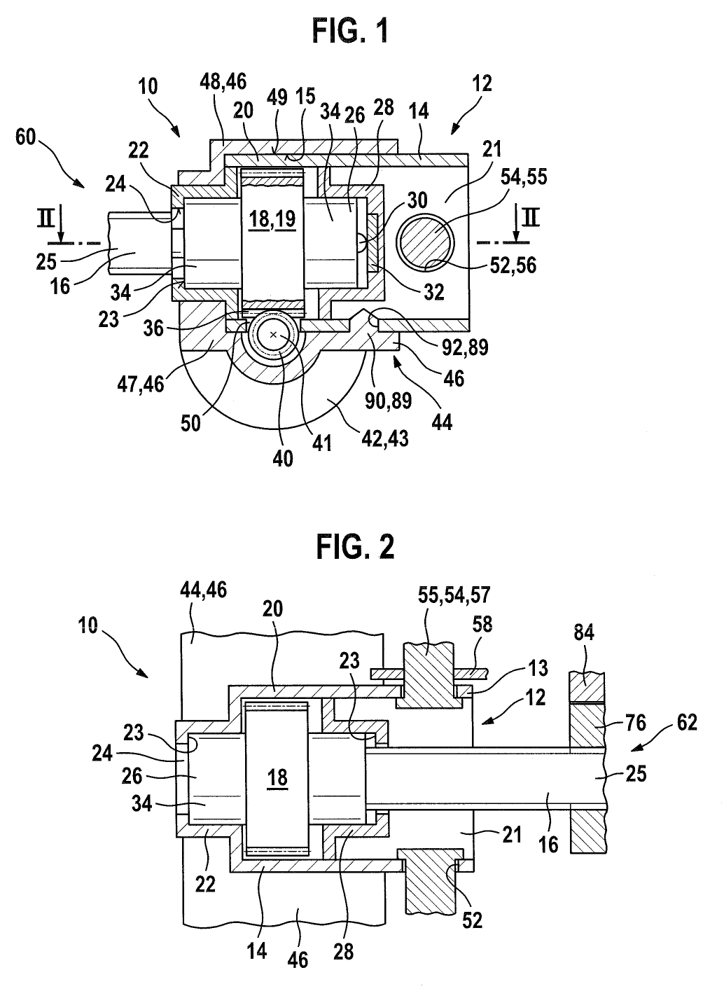

The spindle drive 10 shown in FIG. 1 comprises a first component unit 12, in which a spindle 16 with a drive wheel 18 located on it is supported in a support tube 14. The support tube 14, on a first end region 20, has a first cup-shaped bearing receptacle 22 for the drive wheel 18. With a first end 25, remote from the drive wheel 18, the spindle 16 protrudes through an opening 24 in the first cup-shaped bearing receptacle 22 and out of the support tube 14. The other, second spindle end 26 with the drive wheel 18 is located inside the support tube 14 and is supported axially and radially by means of the first bearing plate 22 and a second bearing plate 28 that contacts the end 26 of the spindle 16.

In FIG. 1, both bearing plates 22 and 28 are embodied as separate components and are secured inside the support tube 14, for instance being placed in it or screwed into it. The spindle end 26 has a spherical stop face 30, which axially contacts the bearing plate 28. Optionally, a stop disk 32 of increased strength can be located in the bearing plate 28. In the exemplary embodiment the drive wheel 18 is embodied as a worm wheel 19, which for radial support has axial extensions 34. The drive wheel 18 is injected from plastic directly onto the spindle 16 or is mounted in a manner fixed against relative rotation and has a set of teeth 36 that meshes with a driven element 40 of a drive assembly 42.

The drive assembly 42 is embodied as an electric motor 43, which has a gearbox 46 that is joined to the first component unit 12 by means of a coupling device 44. An inner contour 49 of the gearbox 46 surrounds an outer contour 15 of the component unit 12. On the inner contour 15, there is at least one radial extension 90, which engages at least one corresponding radial recess 92 in the support tube 14. The radial extensions 90, together with the recesses 92, form fastening means 89 of the coupling device 44 for the component unit 12. In further variant embodiments, the fastening means 89 may also be formed by different form locks.

The gearbox 46 has a base body 47 and a cap 48, which are mounted radially around the support tube 14 and joined together. Upon the connection of the two gearbox parts 47 and 48, the support tube 14 is simultaneously secured to the gearbox 46 via the fastening means 89. For transmitting the driving moment from the drive assembly 42 to the separate component unit 12, the support tube 14 has a radial recess 50, which is engaged by the driven element 40. The driven element 40 is embodied for instance as a worm 39, which is located on an armature shaft 41 of the electric motor 43.

The support tube 14, as practically a standard component, forms a housing for the separate component unit 12, on which housing a receptacle 52 for a fastener 54 is located on the end region 21 diametrically opposite the end 20. As the fastener 54, a link pin 55 can be inserted centrally to the support tube 14 into the receptacle 52, which is embodied as a continuous bore 56. Via this fastener 54, the support tube 14 is connected, for instance pivotably with a part 58 to be adjusted in the motor vehicle, such as a seat or seat part, not further shown, that is adjusted relative to another seat part.

In FIG. 1, the spindle 16 is shown in a first installation position 60, in which the end 25 of the spindle 16 remote from the drive wheel 18 protrudes from the end 20 of the support tube 14 diametrically opposite the receptacle 52. In this first installation position 60, the end 21 toward the receptacle of the support tube 14 protrudes axially past the gearbox 46, so that the receptacle 52 is located axially adjacent to the spindle 16. In this arrangement, a continuous bolt 55 can be inserted as a fastener 54 into the continuous bore 56, resulting in a very stable fastening to the adjusting member 58.

To achieve a shorter spindle drive 10 or a mirror-symmetrical arrangement of the spindle 16, the spindle 16 can be installed, with the drive wheel 18 and the bearing plates 22 and 28, rotated by 180° into the identically located support tube 14, with the flanged-on drive assembly 42. The bearing plate 28 is then located with the central stop face 30 of the spindle 16 in FIG. 1 on the left-hand side on the end 20, and the end 25 of the spindle 16 protrudes toward the right, through the opening 24 in the bearing plate 22 located toward the receptacle 52, out of the end 21 of the support tube 14. In this second installation position 62, shown in terms of a variant in FIG. 2, a continuous bolt 55 cannot be inserted because of the axial overlap of the receptacle 52 with the spindle 16.

FIG. 2 shows a further variant embodiment of a spindle drive 10 in a section taken along the line II-II in FIG. 1, in which the first bearing plate 22 on the end 20 of the support tube 14 is embodied integrally with the support tube, for instance being produced by deep drawing. The bearing plate 22 embodied in one piece with the support tube 14 has the central opening 24, through which the end 25 of the spindle 16 protrudes in the first installation position 60, not shown.

In FIG. 2, the second installation position 62 is shown, in which the end 25 of the spindle 16 protrudes to the right out of the end 21, toward the receptacle, of the support tube 14. The bearing plate 28, toward the receptacle 52, likewise has a central opening 24, through which the end 25 of the spindle 16 protrudes to the outside in the second installation position 62, shown. Since here the receptacle 52 is located axially in the region of the spindle 16, fastening pins 57 are each inserted laterally through the respective bores 56 in the support tube wall 13, and with them the support tube 14 is connected for instance pivotably to the part 58 to be adjusted. A threaded nut 76, which is joined to the vehicle body 84, for instance, is located on the spindle 16.

To attain the first installation position 60, the spindle 16 in FIG. 2 need merely be rotated 180°. The bearing plate 22 together with the support tube 14 remains in the same position, and the bearing plate 28, after the insertion of the spindle 16, is introduced into the support tube 14 again with the end 25, through the opening 24 in the bearing plate 22, and secured. Since in this embodiment both bearing plates 22 and 28 have central openings 24, the spindle 16 is supported axially in both directions on an annular collar 23 of each of the two bearing plates 22, 28. In this second installation position 62, the support tube 14, with its end 20 remote from the receptacle 52, ends approximately flush with the gearbox 46, so that the required installation space on the spindle end 26 is reduced compared to the first installation position 60.

It should be noted that with regard to the exemplary embodiments shown in the drawings and to the description, manifold possible combinations of the individual characteristics with one another can be made. For instance, the support tube 14 can be produced by different methods and can have different concrete shapes. Instead of an integrally formed cup-shaped bearing receptacle 22, the support tube 14 may also be embodied as a smooth cylindrical tube, in which two separate bearing plates 22 and 28 are located for supported the spindle 16.

The spindle 16 is preferably supported via the drive wheel 18 supported thereon, but in a variation can also be supported by means of bearing plates which are integrally formed directly onto the spindle 16. The torque transmission from the drive assembly 42 is not limited to a worm gear 19, 39; it can also be done for instance by means of a spur-gear unit. The cross section of the support tube 14 is not limited to a circle and may for instance be embodied rectangularly or elliptically instead.

Instead of a rotary spindle, a plunging spindle may be located in the support tube 14, which protrudes in both directions from the support tube 14 and past the gearbox 46. The driven wheel 18 is rotatably supported on the spindle 16, and during the adjustment mode the spindle 16 does not rotate but instead is displaced only linearly by the driven wheel 18. The advantage of this version is that with an identical location of the drive assembly 42 and the gearbox 46, in the 180°-rotated installation of the driven wheel 18 with the spindle 16, the receptacle 52 for the fastener 54 extends on the one hand to the left and on the other to the right with regard to the driven wheel 18. This increases the flexibility in installing this kind of plunging spindle drive.

It will be understood that each of the elements described above, or two or more together, may also find a useful application in other types of constructions differing from the type described above.

While the invention has been illustrated and described as embodied in a spindle drive, particularly for adjusting a moving part in a motor vehicle, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A spindle drive, comprising a spindle; a drive wheel supported on said spindle; a drive assembly which drives said drive wheel supported on said spindle; a support tube rotatably supporting said drive wheel and having one end provided with a receptacle for a fastener for diverting crash forces, said spindle being installable in said support tube either in a first installation position or a second installation position rotated by 180°.

2. A spindle drive as defined in claim 1, wherein said receptacle is formed so that in said first installation position said receptacle does not overlap axially with said spindle, and in said second installation position receptacle is located axially in a region of said spindle

3. A spindle drive as defined in claim 1, wherein said receptacle is configured as a continuous bore in said support tube, in which bore in said first installation position a continuous bolt of said fastener is insertable, and in said second installation position two such separate fastener elements each engage a respective bore of a wall of said support tube radially from outside.

4. A spindle drive as defined in claim 1, wherein said drive wheel has two axial extensions supported in two cup-shaped bearing plates which are configured as separate components and in a preassembly are securable in said support tube.

5. A spindle drive as defined in claim 4, wherein one of said cup-shaped bearing plates is configured integrally with said support tube and has a central opening for a passage of said spindle.

6. A spindle drive as defined in claim 4, wherein one of said bearing plates has a central stop face, in which one end of said spindle rests.

7. A spindle drive as defined in claim 6, wherein said one bearing plate is configured as a spherical bearing plate.

8. A spindle drive as defined in claim 4, wherein said drive assembly has a gearbox which surrounds said support tube, and said support tube together with said drive wheel, said bearing plates, and said spindle forming a prefabricated component unit.

9. A spindle drive as defined in claim 8, wherein said gearbox is composed of two parts.

10. A spindle drive as defined in claim 8, wherein said gearbox is mountable radially on said support tube and has as fastening means at least one radially inward oriented extension that engages at least one recess in said support tube.

11. A spindle drive as defined in claim 8, wherein said support tube in said second installation position substantially does not protrude axially past said gearbox on an end remote from said receptacle of said spindle.

12. A spindle drive as defined in claim 1, wherein the spindle drive is configured as a spindle drive for adjusting a moving part in a motor vehicle.

13. A method for producing a spindle drive, comprising the steps of providing a drive assembly which drives a drive wheel supported on a spindle; tube rotatably supporting the drive wheel by a support tube having one end provided with a receptacle for a fastener for diverting crash forces; and installing the spindle in the support tube either in a first installation position or a second installation position rotated by 180°.

14. A method as defined in claim 13, wherein for the first installation position the spindle with an end diametrically opposite the derive wheel leading, is thrust into the one end toward the receptacle of the support tube and pushed through an opening in a bearing plate remote from the receptacle until the drive wheel rests on the bearing plate, and after that a second bearing plate is introduced into the support tube and secured in it, while for the second installation position first the spindle with an end toward the drive wheel leading is thrust into the one end toward the receptacle of the support tube until the drive wheel rests on the first mentioned bearing plate remote from the receptacle and after that the second bearing plate is introduced with a central opening of a spindle into the support tube and secured there.
